(19) United States
(12) Patent Application Publication
(10) Pub. No.: US 2013/0003713 A1
(43) Pub. Date: Jan. 3, 2013

(54) COMMUNICATION METHOD AND COMMUNICATION SYSTEM

(75) Inventor: Satoshi HIRATSUKA, Tokyo (JP)

(73) Assignee: NEC CORPORATION, Tokyo (JP)

(21) Appl. No.: 13/538,349

(22) Filed: Jun. 29, 2012

(30) Foreign Application Priority Data
Jun. 29, 2011 (JP) 2011-143823

(51) Int. Cl. H04J 3/00

(52) U.S. Cl. 370/345

(57) ABSTRACT

A first communication device generates a control header containing mapping information indicating channels to which data of time division multiplex is mapped, maps the data of time division multiplex and data of another format to respective channels according to the mapping information, and transmits a signal in which the data of time division multiplex and the data of the other format have been mapped and the control header, and a second communication device receives the signal in which the data of time division multiplex and the data of the other format have been mapped and the control header, acquires the mapping information from the control header, and acquires the data of time division multiplex and the data of the other format from the respective channels of the signal according to the mapping information.

### BACKGROUND OF THE INVENTION

1. Field of the Invention

The present invention relates to a technology for mixing data of time division multiplex communication and data of another format of communication and performing communication.

Priority is claimed on Japanese Patent Application No. 2011-143823, filed Jun. 29, 2011, the contents of which are incorporated herein by reference.

2. Description of Related Art

In recent years, with the great increase in data traffic, service providers need a large-scale network configuration. Further, there is a movement to change all communications into IP (Internet Protocol) communication in a mobile backhaul area. With such a movement, a shift from TDM (Time Division Multiplex) to Ethernet (registered trademark) has been actualized. Accordingly, a demand for an increase in Ethernet and decrease in TDM is increasing. However, it is difficult to rapidly replace all TMDs with Ethernet. Because of this, a technology for transmitting TDM data and Ethernet data in a mixed form has been proposed (see Patent Document 1: Japanese Unexamined Patent Application, First Application No. 2004-349782).

Traditionally, Ethernet data is mapped to a channel of TDM communication and a plurality of channels are capsulated to generate one frame. When the Ethernet data is mapped to the channel of TDM communication, the mapping is performed according to mapping information that has been set on a transmitting side and a reception side in advance.

If mapping information differs between a transmission side and a reception side, it is impossible to correctly restore data at the reception side when a radio frame is decapsulated. In this case, the data that could not be restored is discarded as incorrect data. Accordingly, when the mapping information is changed at either the transmission side or the reception side, data may be discarded until the mapping information matches.

### SUMMARY OF THE INVENTION

The present invention has been made in view of the circumstances described above, and an object of the present invention is to provide a technology for reducing data that is discarded when mapping information is changed.

According to one aspect of the present invention, a communication method of time-division-multiplexing data of time division multiplex and data of another format and performing communication between a first communication device and a second communication device is provided, the method including: a step of generating, by the first communication device, a control header containing mapping information indicating channels to which the data of time division multiplex is mapped; a mapping step of mapping, by the first communication device, the data of time division multiplex and the data of the other format to the respective channels according to the mapping information; a step of transmitting, by the first communication device, a signal in which the data of time division multiplex and the data of the other format have been mapped and the control header; a step of receiving, by the second communication device, the signal in which the data of time division multiplex and the data of the other format have been mapped and the control header; a step of acquiring, by the second communication device, the mapping information from the control header; and a release step of acquiring, by the second communication device, the data of time division multiplex and the data of the other format from the respective channels of the signal according to the mapping information.

According to one aspect of the present invention, a communication system for time-division-multiplexing data of time division multiplex and data of another format and performing communication between a first communication device and a second communication device is provided, wherein: the first communication device includes: a frame generation unit which generates a control header containing mapping information indicating channels to which the data of time division multiplex is mapped, and maps the data of time division multiplex and the data of the other format to the respective channels according to the mapping information; and a transmission unit which transmits a signal in which the data of time division multiplex and the data of the other format have been mapped and the control header, and the second communication device includes: a reception unit which receives the signal in which the data of time division multiplex and the data of the other format have been mapped and the control header; and a division unit which acquires the mapping information from the control header and acquires the data of time division multiplex and the data of the other format from the respective channels of the signal according to the mapping information.

According to the present invention, it is possible to reduce data that is discarded when mapping information is changed.

### BRIEF DESCRIPTION OF THE DRAWINGS

FIG. 1 is a system configuration diagram showing a system configuration of a communication system;

FIG. 2 is a schematic diagram showing a radio frame transmitted or received in the communication system;

FIG. 3 is a diagram showing a configuration of a wireless communication unit included in a communication device;

FIG. 4 is a diagram showing a detailed functional configuration of a line signal processing unit;

FIG. 5 is a diagram showing schematic data processing in transmission;

FIG. 6 is a diagram showing schematic data processing in reception;

FIG. 7 is a diagram showing a structure of a frame of a control header;

FIG. 8 is a flowchart showing a flow of a process when mapping information is designated;

FIG. 9 is a flowchart showing a flow of a process when a line signal processing unit generates a radio frame; and

FIG. 10 is a flowchart showing a flow of a process when the line signal processing unit receives a radio frame.

### DETAILED DESCRIPTION OF THE INVENTION

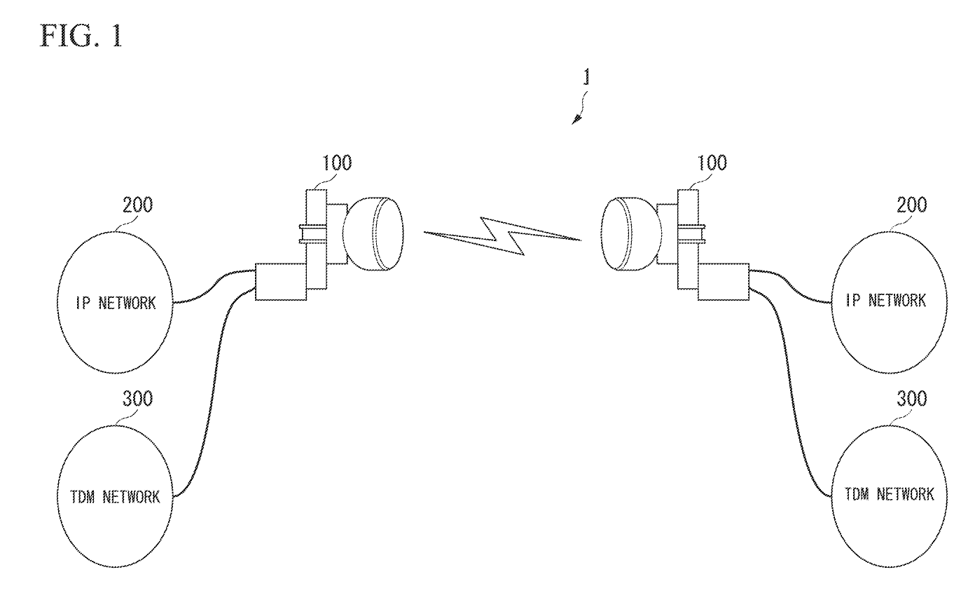

Hereinafter, embodiments of the present invention will be described with reference to the drawings. FIG. 1 is a system configuration diagram showing a system configuration of a communication system 1. The communication system 1 includes a plurality of communication devices 100, and IP networks 200 and TDM networks 300 to which the respective communication devices 100 are connected. For example, the communication device 100 at a left side is a transmitting side and the communication device 100 at a right side is a reception side.

The communication device 100 at the transmitting side receives data of Ethernet (hereinafter referred to as “Ethernet data”) from the IP network 200. Also, the communication device 100 at the transmitting side receives data of TDM (hereinafter referred to as “TDM data”) from the TDM network 300. The communication device 100 at the transmitting side generates a radio frame in which the TDM data and the Ethernet data are mixed, and transmits the radio frame. If the communication device 100 at the reception side receives the radio frame, the communication device 100 at the reception side restores the TDM data and the Ethernet data from the radio frame. Also, the communication device 100 at the reception side transmits the restored Ethernet data to the IP network 200 and the restored TDM data to the TDM network 300.

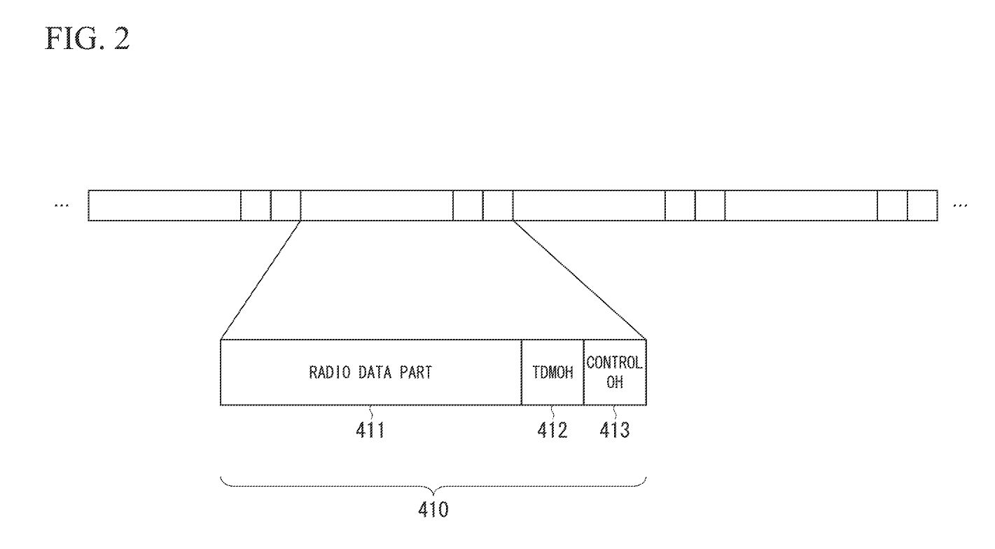

FIG. 2 is a diagram showing a schematic radio frame transmitted or received in the communication system 1. The communication device 100 transmits a plurality of radio frames 410. One radio frame 410 contains a radio data part 411, a TDMOH (Time Division Multiplex OverHead) 412, and a control OH (control OverHead). The radio data part 411 is generated by capsulating the TDM data and the Ethernet data. The TDMOH 412 is an overhead for TDM communication. The control OH 413 will be described later.

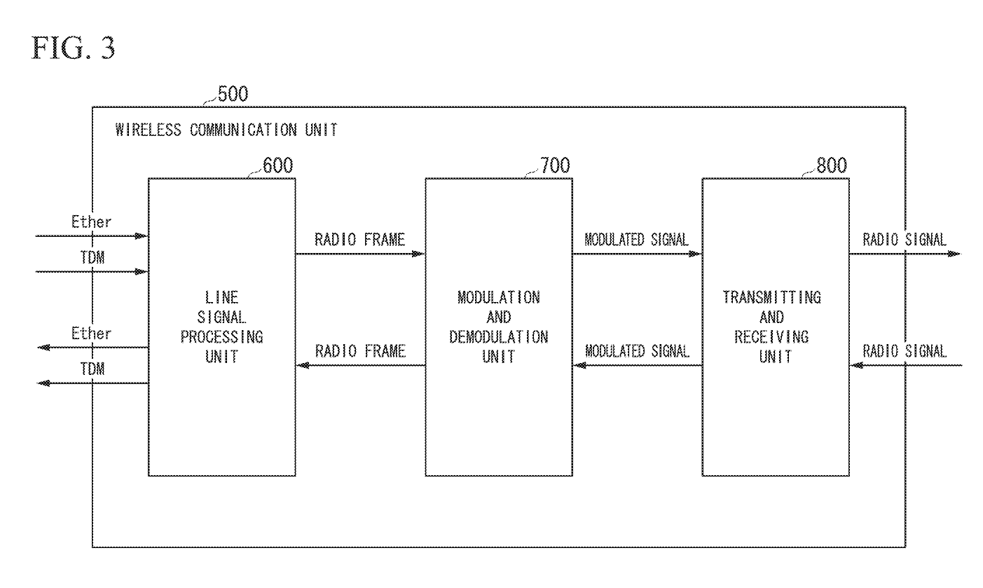

FIG. 3 is a diagram showing a configuration of a wireless communication unit 500 included in the communication device 100. The wireless communication unit 500 includes a line signal processing unit 600, a modulation and demodulation unit 700, and a transmission and reception unit 800.

First, a process of each component included in the wireless communication unit 500 in transmission will be described. The line signal processing unit 600 receives TDM data and Ethernet data to be transmitted by the communication device 100 from a data processing unit (not shown) of the communication device 100. The data processing unit performs a process of relaying data received from the IP network 200 and data received from the TDM network 300. The line signal processing unit 600 capsulates the received TDM data and the received Ethernet data into a radio frame. The line signal processing unit 600 assigns a TDM overhead (TDMOH 412) and a control header (control OH 413) as a header when performing the above-described capsulation.

The control header contains mapping information indicating a channel of the radio frame to which the TDM data has been mapped. The mapping information may indicate the number of channels to which the TDM data has been mapped in the radio data part 411. The modulation and demodulation unit 700 modulates the radio frame to a radio signal. The transmission and reception unit 800 transmits the radio signal to another communication device 100.

Next, a process of each component included in the wireless communication unit 500 in reception will be described. The transmission and reception unit 800 receives a radio signal transmitted from the other communication device 100. The modulation and demodulation unit 700 demodulates the radio signal to restore a radio frame. The line signal processing unit 600 decapsulates the radio frame based on the control header to thereby restore the TDM data and the Ethernet data. Also, the line signal processing unit 600 transmits the TDM data and the Ethernet data to the data processing unit in the device.

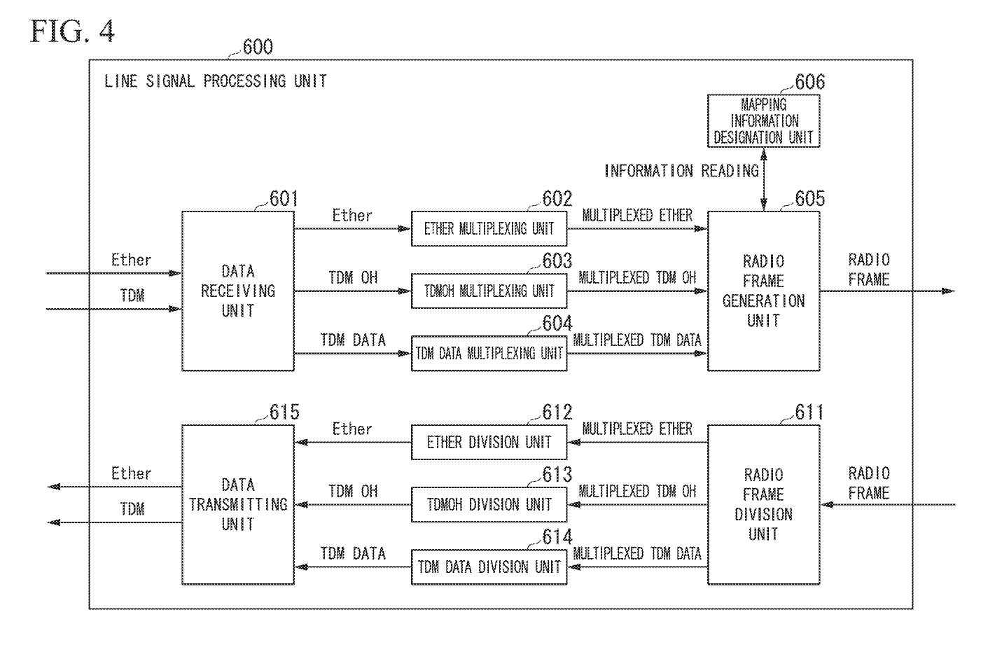

FIG. 4 is a diagram showing a detailed functional configuration of the line signal processing unit 600. The line signal processing unit 600 includes a data receiving unit 601, an Ether multiplexing unit 602, a TDMOH multiplexing unit 603, a TDM data multiplexing unit 604, a radio frame generation unit 605, a mapping information designation unit 606, a radio frame division unit 611, an Ether division unit 612, a TDMOH division unit 613, a TDM data division unit 614, and a data transmission unit 615.

The data receiving unit 601 terminates respective signals of the Ethernet data and the TDM data received from the data processing unit of the communication device 100. The data receiving unit 601 transmits the Ethernet data to the Ether multiplexing unit 602. The data receiving unit 601 transmits the TDM overhead used for TDM communication in the device, of the TDM data, to the TDMOH multiplexing unit 603. The data receiving unit 601 transmits data of a part (hereinafter referred to as “TDM payload”) other than the TDM overhead of the TDM data to the TDM data multiplexing unit 604.

The Ether multiplexing unit 602 multiplexes the Ethernet data for a radio frame. Specifically, the Ether multiplexing unit 602 time-division-multiplexes the Ethernet data by mapping the Ethernet data to each channel of the TDM communication, which is performed between the communication devices 100. Also, the Ether multiplexing unit 602 transmits the multiplexed Ethernet data to the radio frame generation unit 605.

The TDMOH multiplexing unit 603 multiplexes the TDMOH for the radio frame. Also, the TDMOH multiplexing unit 603 transmits the multiplexed TDMOH to the radio frame generation unit 605.

The TDM data multiplexing unit 604 multiplexes the TDMA payload for the radio frame. Specifically, the TDM data multiplexing unit 604 time-division-multiplexes the TDMA payload by mapping the TDMA payload to each channel of the TDM communication, which is performed between the communication devices 100. Also, the TDMA datamultiplexing unit 604 transmits the multiplexed TDMA payload to the radio frame generation unit 605.

The mapping information designation unit 606 receives a designation of the number of channels of the TDM data mapped to one radio frame from the outside. The designation from the outside may be performed in any form. For example, an input device such as a keyboard connected to the communication device 100 or the wireless communication unit 500 may be manipulated by a person to designate the channel number. For example, an information processing device connected to the communication device 100 or the wireless communication unit 500 may be manipulated by a person to designate the channel number. For example, an information processing device at a remote place that performs wired communication or wireless communication with the communication device 100 or the wireless communication unit 500 may be manipulated by a person to designate the channel number. The mapping information designation unit 606 stores the designated channel number (the mapping information).

The radio frame generation unit 605 reads the mapping information from the mapping information designation unit 606. The radio frame generation unit 605 capsulates the respective received data into the radio frame according to the read mapping information. Also, the radio frame generation unit 605 generates a control header indicating the mapping information and assigns the control header to the radio frame. Also, the radio frame generation unit 605 transmits the radio frame to the modulation and demodulation unit 700.

The radio frame division unit 611 receives the radio frame from the modulation and demodulation unit 700. The radio frame division unit 611 reads the mapping information indicated by the control header of the received radio frame. The radio frame division unit 611 divides the radio frame according to the mapping information. Specifically, the radio frame division unit 611 divides the radio frame into the multiplexed Ethernet data, the multiplexed TDM overhead, and the multiplexed TDM payload. Also, the radio frame division unit 611 transmits the multiplexed Ethernet data to the Ether division unit 612, the multiplexed TDM overhead to the TDMOH division unit 613, and the multiplexed TDM payload to the TDM data division unit 614.

The Ether division unit 612 divides the Ethernet data multiplexed for the radio frame to restore the Ethernet data. Also, the Ether division unit 612 transmits the Ethernet data to the data transmission unit 615. The TDMOH division unit 613 divides the TDM overhead multiplexed for the radio frame to restore the TDM overhead. Also, the TDMOH division unit 613 transmits the TDM overhead to the data transmission unit 615. The TDM data division unit 614 divides the TDM payload multiplexed for the radio frame to restore the TDM payload. Also, the TDM data division unit 614 transmits the TDM payload to the data transmission unit 615.

The data transmission unit 615 transmits the Ethernet data received from the Ether division unit 612 to the data processing unit. The data transmission unit 615 combines the TDM overhead received from the TDMOH division unit 613 and the TDM payload received from the TDM data division unit 614 to restore the TDM data, and transmits the TDM data to the data processing unit.

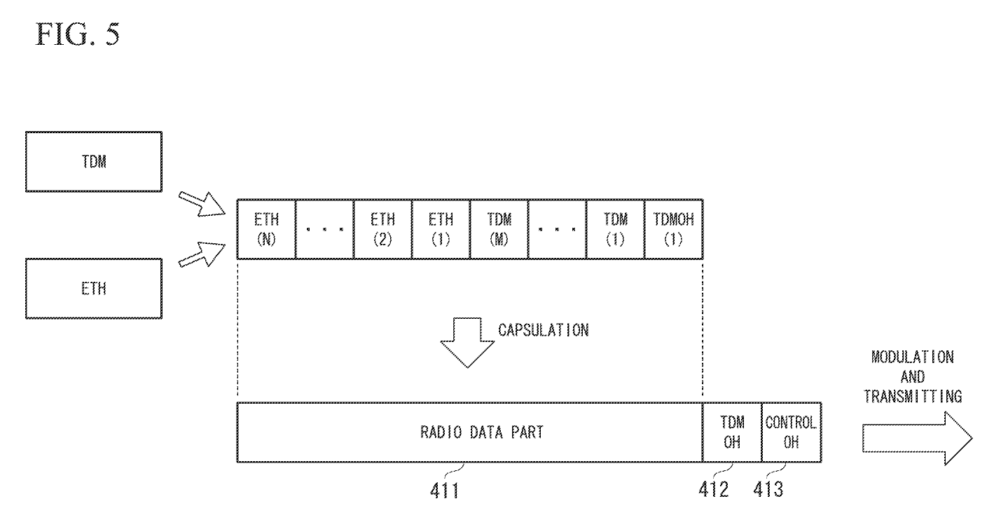

FIG. 5 is a diagram showing schematic data processing in transmission. In FIG. 5, a rectangle indicated by TDM indicates the TDM data, and a rectangle indicated by ETH indicates the Ethernet data. The radio frame generation unit 605 maps the multiplexed TDM overhead and the multiplexed TDM payload to channels corresponding to the channel number designated by the mapping information designation unit 606. In the case of FIG. 5, the multiplexed TDM overhead is mapped to TDMOH (1). The multiplexed TDM payload is mapped to TDM (1) to TDM (M).

The radio frame generation unit 605 may store the number of channels included in one radio data part 411 (hereinafter referred to as a “total channel number”) in advance. The radio frame generation unit 605 subtracts the channel number designated by the mapping information designation unit 606 (M+1 in the case of FIG. 5) from the total channel number to calculate the number of channels to which the Ethernet data is mapped (N in the case of FIG. 5). The radio frame generation unit 605 maps the multiplexed Ethernet data to such a calculated number of channels. The multiplexed Ethernet data is mapped to ETH (1) to ETH (N). Either the Ethernet data or the TDM data to be mapped to a front side of the radio data part 411 may be set in the radio frame generation unit 605 in advance. For example, in the case of FIG. 5, the TDM data is mapped to the front side of the radio data part 411 and the Ethernet data is mapped to a rear side of the TDM data.

The radio frame generation unit 605 generates header information on the time division multiplex performed by the radio frame generation unit 605 and assigns the header information to the radio data part 411 as the TDM overhead (TDMOH) 412. Also, the radio frame generation unit 605 generates a control header indicating the mapping information read from the mapping information designation unit 606 and assigns the control header to the radio data part 411 as the control OH 413. Through this process, the radio frame 410 is generated.

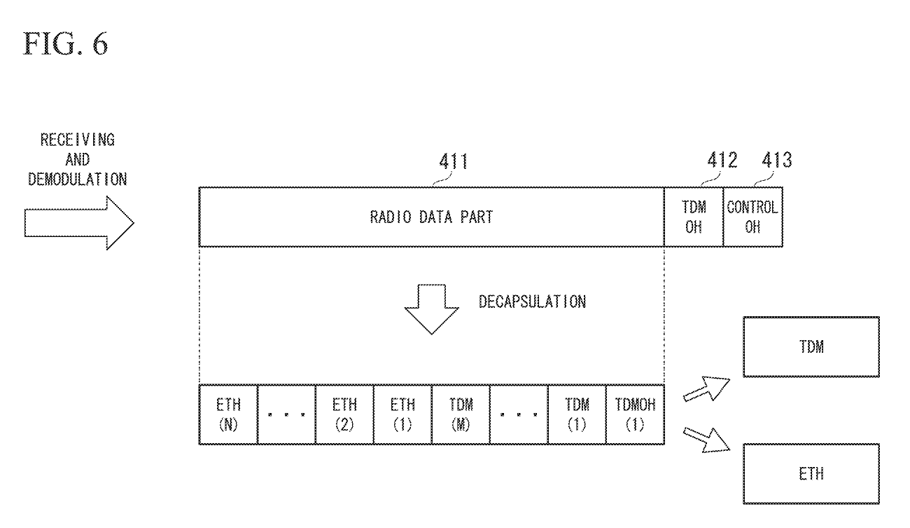

FIG. 6 is a diagram showing schematic data processing in reception. Descriptions relating to FIG. 6 are the same as those in FIG. 5. The radio frame division unit 611 extracts the control header (the control OH 413) contained in the radio frame and acquires the channel number of each of the TDM data and the Ethernet data mapped to the radio frame. For example, the radio frame division unit 611 counts the channels corresponding to the channel number set in the control OH 413 from the front side of the radio data part 411, and extracts data of the counted channels as the multiplexed TDM data (the TDMOH and the TDM payload). Also, the radio frame division unit 611 extracts data of other channels of the radio data part 411 as the multiplexed Ethernet data.

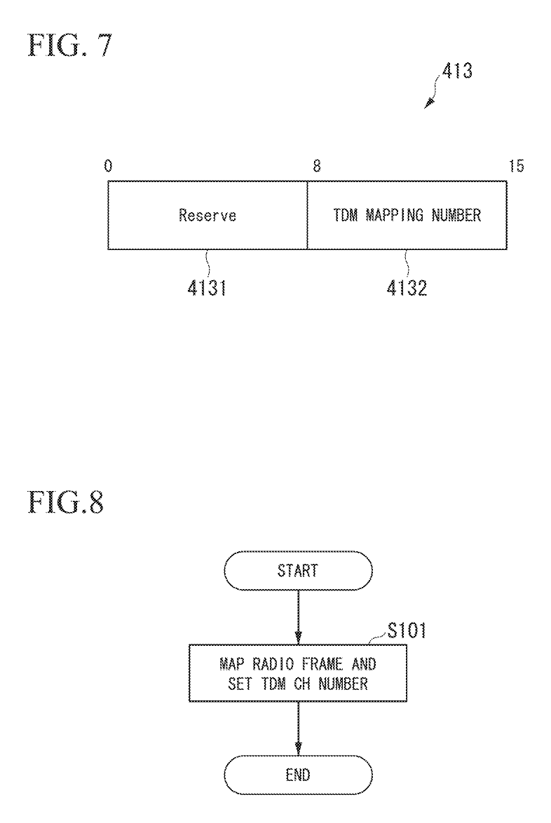

FIG. 7 is a diagram showing a structure of a frame of the control header. The control header 413 includes a reserve area 4131 and a TDM mapping number area 4132. The control header consists of, for example, a 16-bit data sequence. The first half 8-bit area is the reserve area 4131 and the second half 8-bit area is the TDM mapping number area. When the control header is a binary number “0000000000001100,” the TDM mapping number area 4132 indicates a decimal number “12.” Such a control header 413, the channel number of the TDM data mapped to the radio data part 411 of the radio frame is 12, and the Ethernet data is mapped to all other channels. Further, the reserve area 4131 is an area for extension and all bits thereof are, for example, “0.”

FIG. 8 is a flowchart showing a flow of a process when the mapping information is designated. When a person manipulates, for example, a keyboard to designate the mapping information, the mapping information designation unit 606 receives the designated mapping information. Also, the mapping information designation unit 606 stores the designated mapping information to complete setting of the mapping information (step S101).

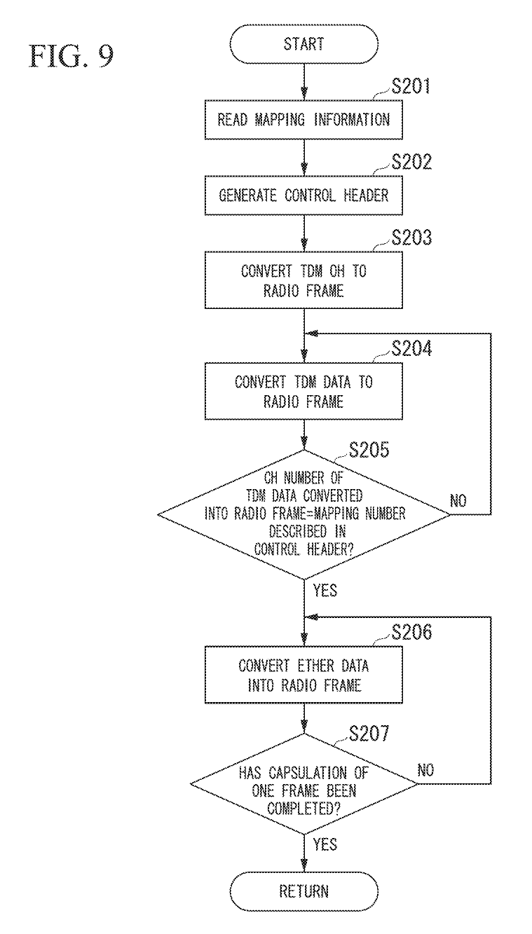

FIG. 9 is a flowchart showing a flow of a process when the line signal processing unit 600 generates the radio frame. First, the radio frame generation unit 605 reads the mapping information from the mapping information designation unit 606 (step S201). Next, the radio frame generation unit 605 generates the control header based on the read mapping information (step S202). Next, the radio frame generation unit 605 maps the TDM overhead received from the TDMOH multiplexing unit 603 to the radio data part 411 (step S203). Next, the radio frame generation unit 605 maps the TDM payload received from the TDM data multiplexing unit 604 to the radio data part 411 according to the mapping information (steps 5204 and S205). Specifically, the radio frame generation unit 605 maps the TDM payload until the channel number becomes the channel number indicated by the mapping information. Next, the radio frame generation unit 605 maps the Ethernet data to all the other channels (step S206). Since the multiplexing process of one radio frame is completed (step S207-YES), the radio frame generation unit 605 transmits the generated radio frame to the modulation and demodulation unit 700, and iteratively executes a process of generating a next radio frame. A size of one radio frame varies with a modulation scheme.

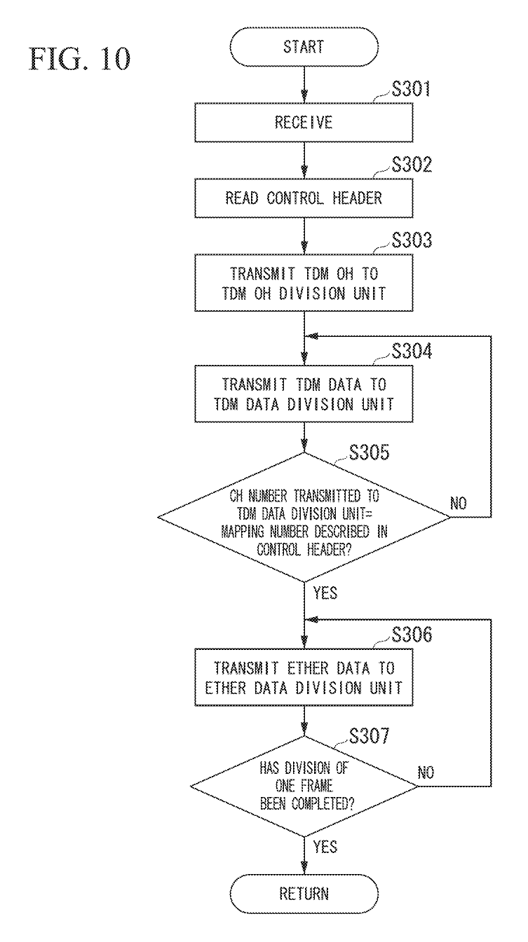

FIG. 10 is a flowchart showing a flow of a process when the line signal processing unit 600 receives a radio frame. First, the radio frame division unit 611 receives the radio frame received by the transmission and reception unit 800 and demodulated by the modulation and demodulation unit 700, from the modulation and demodulation unit 700 (step S301). Next, the radio frame division unit 611 reads the control header from the received radio frame (step S302). Next, the radio frame division unit 611 extracts the multiplexed TDMOH from the front part of the radio data part 411 and transmits the multiplexed TDMOH to the TDMOH division unit 613 (step S303). Next, the radio frame division unit 611 reads the mapping information from the control header. The radio frame division unit 611 extracts the TDM data from each channel of the radio data part 411 until the channel number matches the channel number indicated by the mapping information. The radio frame division unit 611 transmits the extracted TDM data to the TDM data division unit 614 (steps 5304 and S305). Next, the radio frame division unit 611 extracts the Ethernet data from all the other channels and transmits the Ethernet data to the Ether division unit 612 (steps 5306 and S307-YES).

In the above-described communication system 1, it is possible to reduce data that is discarded when the mapping information is changed. Detailed effects are as follows:

For example, in a related art, when a TDM band decreases and an Ethernet band increases, data may be discarded at a time when mapping information of either the communication device 100 at the transmission side or the communication device 100 at the reception side has been changed. The data discard is continued until the mapping information matches between the transmission side and the reception side. Since high quality is required in a mobile backhaul area, data discard (loss) is not allowed. According to necessity, facility increase or decrease must be carried out after the data completely stops.

On the other hand, in the communication system 1 described above, when the mapping information is changed at the transmission side, the changed mapping information is transmitted to the reception side as a radio frame. At the reception side, the radio frame received together with mapping information is divided to restore the TDM data and the Ethernet data based on the received mapping information. Accordingly, it is possible to match the mapping information between the transmission side and the reception side immediately after the change of the mapping information has been reflected at the transmission side. Thus, it is possible to reduce the occurrence of data discard.

Further, the above-described communication system 1 can be realized without greatly changing a conventional device. That is, the communication system 1 can be realized by adding the radio frame generation unit 605 and the mapping information designation unit 606 of the line signal processing unit 600 to a conventional communication system. Accordingly, for example, the communication system 1 can be realized with only a version upgrade of an FPGA (Field-programmable Gate Array) without changing conventional hardware

<Variant>

In the above description, the TDMOH and the TDM data are divided and then processed. However, since the TDMOH is used for communication in the device, the TDMOH multiplexing unit 603 and the TDMOH division unit 613 may be omitted. Further, the TDM data multiplexing unit 604 may also perform the process of the TDMOH multiplexing unit 603 and the TDM data division unit 614 may also perform the process of the TDMOH division unit 613.

A frame size of the control header in the above description may have a different length from that described above

Data mixed with the TDM data and then transmitted is not limited to the Ethernet data.

Communication performed by the communication device 100 is not limited to the wireless communication and may be wired communication.

While the embodiments of the present invention have been described above, a concrete configuration is not limited to such embodiments and various variations without departing from the scope and spirit of the present invention fall within the present invention.

What is claimed is:

1. A communication method of time-division-multiplexing data of time division multiplex and data of another format and performing communication between a first communication device and a second communication device, the method comprising:
a step of generating, by the first communication device, a control header containing mapping information indicating channels to which the data of time division multiplex is mapped;
a mapping step of mapping, by the first communication device, the data of time division multiplex and the data of the other format to the respective channels according to the mapping information;
a step of transmitting, by the first communication device, a signal in which the data of time division multiplex and the data of the other format have been mapped and the control header;
a step of receiving, by the second communication device, the signal in which the data of time division multiplex and the data of the other format have been mapped and the control header;
a step of acquiring, by the second communication device, the mapping information from the control header; and
a release step of acquiring, by the second communication device, the data of time division multiplex and the data of the other format from the respective channels of the signal according to the mapping information.

2. The communication method according to claim 1, wherein
the mapping step includes:
a step of mapping, by the first communication device, the data of time division multiplex to the respective channels according to the mapping information; and
a step of mapping, by the first communication device, the data of the other format to respective other channels to which the data of time division multiplex has not been mapped, and
the releasing step includes:
a step of acquiring, by the second communication device, the data of time division multiplex from the respective channels of the signal according to the mapping information; and
a step of acquiring, by the second communication device, the data of the other format from the respective other channels to which the data of time division multiplex has not been mapped.

3. A communication system for time-division-multiplexing data of time division multiplex and data of another format and performing communication between a first communication device and a second communication device, wherein:
the first communication device includes:
a frame generation unit which generates a control header containing mapping information indicating channels to which the data of time division multiplex is mapped, and maps the data of time division multiplex and the data of the other format to the respective channels according to the mapping information; and
a transmission unit which transmits a signal in which the data of time division multiplex and the data of the other format have been mapped and the control header, and
the second communication device includes:
a reception unit which receives the signal in which the data of time division multiplex and the data of the other format have been mapped and the control header; and
a division unit which acquires the mapping information from the control header and acquires the data of time division multiplex and the data of the other format from the respective channels of the signal according to the mapping information.
